(19) United States
(12) Patent Application Publication
(10) Pub. No.: US 2002/0047863 A1
(43) Pub. Date: Apr. 25, 2002

(54) Method and system for creating software applications in a visual development environment

(75) Inventor: Michael Irvin Hyman, Seattle, WA (US)

Correspondence Address: MERCHANT & GOULD PC, P.O. BOX 2903, MINNEAPOLIS, MN, 55402-0903, US

(73) Assignee: DataChannel, Inc.

(21) Appl. No.: 09/975,578

(22) Filed: Oct. 10, 2001

Related U.S. Application Data
(60) Provisional application No. 60/243,379, filed on Oct. 25, 2000.

(51) Int. Cl. G09G 5/00

(52) U.S. Cl. 345/744; 345/749

(57) ABSTRACT

A method and system for displaying server-side components in a visual development environment. Upon a triggering event, code is requested from a server. The code represents a user interface for a server-side object. The code is then processed to deactivate interactive elements. Further processing may occur to fix references to images. Then, a graphical representation of the server-side object is displayed in the visual development environment.

### RELATED APPLICATION

This application is a Utility Patent application based on a previously filed U.S. Provisional Patent application, U.S. Serial No. 60/243,379 filed on Oct. 25, 2000, the benefit of the filing date of which is hereby claimed under 35 U.S.C. § 119(e).

### FIELD OF THE INVENTION

The present invention relates to software development tools, and in particular to software development tools that display visual representations of objects.

### BACKGROUND

Developing content accessed over the World Wide Web can be done in many different ways. In one approach, a software developer creates a page using a simple text editor, saves the text to a page on a Web server, and loads the page into a browser. The page looks the same to each user who downloads the page. That is, the page is static and does not change the way it appears based on who is downloading the page or other factors.

In another approach, a software developer creates a program or object (both called hereafter object) that is executed when a request for the page is received. When completed, the object is downloaded to a Web server that executes the object when a page the object builds is requested.

A software application that operates using the World Wide Web or some other network is not limited to browsers and Web servers. A software application may consist of a portion that resides on the computer a user is using (also known as a client) and a portion that resides on another computer (usually known as a server). The client computer may simply display data and collect and transmit user input, i.e. act as a dumb terminal, or it may receive raw data from the server, perform calculations on the data to obtain other values, format the data for the display, receive and validate input from the user, and perform other functions.

Such a software application typically has client components and server components. The client components and server components interact with each other to perform the tasks the user desires. Depending on the configuration, the work may be evenly or unevenly distributed between the client computer and the server. For example, a client computer may use the server to store documents such as spreadsheets and text documents. The client computer may perform the calculations dictated by formulas or macros in the spreadsheet and simply use the server to store the raw numbers. In a word processing application, the client computer may format the text in proportional-spaced font, perform left, right, or full justification of the text, divide the text into pages, spell-check, and perform other word processing functions. When saving a document, the client computer may package the document into codes and formats and send a bit stream to the server computer for storage.

When developing a software application that has client and server components, a way of visually displaying how certain screens in the application will appear without executing the application is useful. Graphically displaying client-side components is typically done, but displaying server-side components is problematic.

### SUMMARY

In accordance with the present invention, there is provided a method and system for displaying server-side components in a visual development environment. Upon a triggering event, code is requested from a server that represents a user interface for an object. The code is then processed removing interactive elements, e.g., items that would cause an action to be taken if activated. Such items include scripts and code for a button that if selected causes a new window to open or the visual development environment to lose focus. Further processing may also occur to fix references to images. Then, a graphical representation of the server-side component (object) is displayed.

In one aspect of the invention, fixing references to images includes replacing one reference to the image with another reference to the image. For example, a server-side object may include a relative reference to an image. While the object resides on the server, the reference is sufficient to locate the image. When code for the object is exported, however, this relative reference may be replaced with another reference, such as an absolute reference.

In another aspect of the invention, triggering events include such things as placing an icon associated with the server-side object on a page in a visual development environment, changing a property of a control, opening a file containing a control in the visual development environment, refreshing the visual development environment, polling that indicates that the server-side object has changed, and a message sent from a server indicating that the server-side object has changed.

In another aspect of the invention, objects are represented using a markup language such as the hypertext markup language (HTML) or an extensible markup language (XML).

In another aspect of the invention, a server-side object that is transformed into graphical representation and displayed in the visual development environment looks visually similar to what would be generated if an application requesting the server-side object executed and displayed the server-side object. In other words, there is virtually no difference between the look of the object in the visual development environment and in production. Sometimes the graphical representation in the visual development environment is referred to as a proxy for the server-side object.

In another aspect of the invention, components of the invention may be embodied in a computer-readable medium or encoded in a modulated data signal.

In another aspect of the invention, a visual development environment is coupled to a server which is coupled to an object repository. Upon a triggering event, the visual development environment requests code regarding a server-side object from the server which then retrieves the code using the object repository. The object repository may be stored on the server.

These and various other features as well as advantages, which characterize the present invention, will be apparent from a reading of the following detailed description and a review of the associated drawings.

### BRIEF DESCRIPTION OF THE DRAWINGS

FIGS. 1-3 show components of an exemplary environment in which the invention may be practiced;

FIG. 4 illustrates an exemplary environment in which the invention operates in which clients executing visual development environments are coupled to a server having access to server objects;

FIG. 5 shows a flow chart for displaying a client-side interface for a server-side object;

FIG. 6 illustrates events that may trigger a request of the client-side UI for a server-side object;

FIG. 7 shows a flow chart for obtaining and processing a client-side user interface;

FIG. 8 shows an exemplary visual development environment with some client-side user interfaces displayed;

FIGS. 9-10 illustrate code for a server-side object that has been transformed into code for a client-side user interface in accordance with the invention.

### DETAILED DESCRIPTION

In the following detailed description of exemplary embodiments of the invention, reference is made to the accompanied drawings, which form a part hereof, and which are shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined by the appended claims.

In the following description, first an illustrative operating environment in which the invention may be practiced is disclosed. Then, an exemplary development environment including software development environments and a server is described. Next, an illustrative method for displaying a client-side user interface for a server-side object is disclosed. Then, an illustrative visual development environment is described. Finally, an exemplary transformation of a server-side object into a client-side user interface is described.

Illustrative Operating Environment

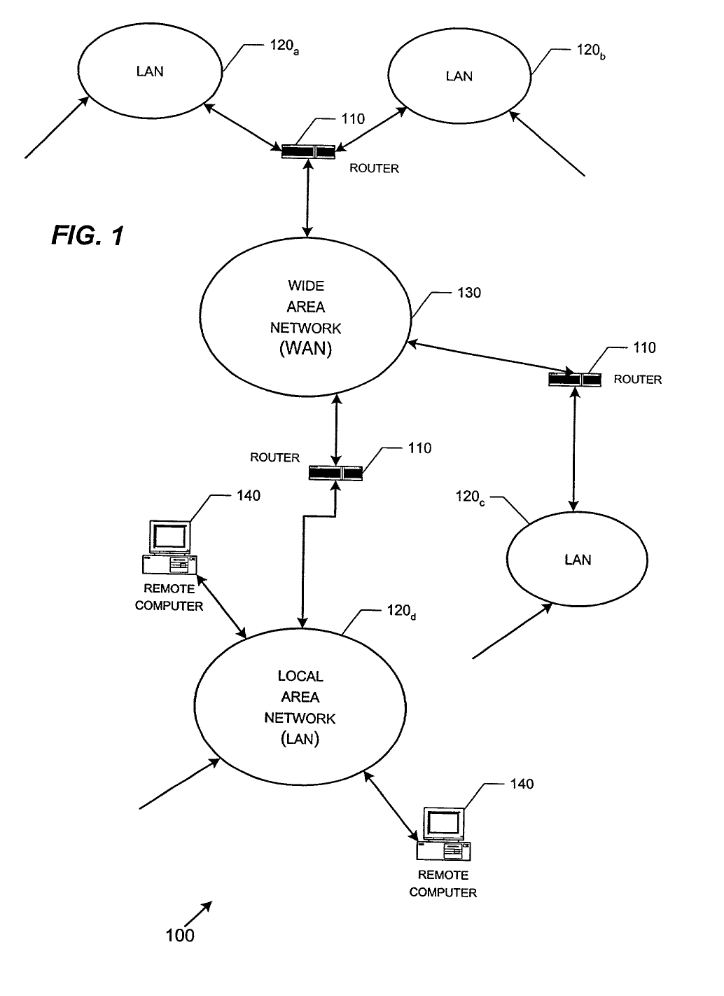

FIGS. 1-3 show components of an exemplary environment in which the invention may be practiced. Not all the components may be required to practice the invention, and variations in the arrangement and type of the components may be made without departing from the spirit or scope of the invention.

FIG. 1 shows a plurality of local area networks (“LANs”) 120_{a-d} and wide area network (“WAN”) 130 interconnected by routers 110. Routers 110 are ;intermediary devices on a communications network that expedite message delivery. On a single network linking many computers through a mesh of possible connections, a router receives transmitted messages and forwards them to their correct destinations over available routes. On an interconnected set of LANs—including those based on differing architectures and protocols—, a router acts as a link between LANs, enabling messages to be sent from one to another. Communication links within LANs typically include twisted pair, fiber optics, or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links, or other communications links known to those skilled in the art. Furthermore, computers, such as remote computer 140, and other related electronic devices can be remotely connected to either LANs 120_{a-d} or WAN 130 via a modem and temporary telephone link. The number of WANs, LANs, and routers in FIG. 1 may be increased or decreased arbitrarily without departing from the spirit or scope of this invention.

As such, it will be appreciated that the Internet itself may be formed from a vast number of such interconnected networks, computers, and routers. Generally, the term “Internet” refers to the worldwide collection of networks, gateways, routers, and computers that use the Transmission Control Protocol/Internet Protocol (“TCP/IP”) suite of protocols to communicate with one another. At the heart of the Internet is a backbone of high-speed data communication lines between major nodes or host computers, including thousands of commercial, government, educational, and other computer systems, that route data and messages. An embodiment of the invention may be practiced over the Internet without departing from the spirit or scope of the invention.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media such as twisted pair, coaxial cable, fiber optics, wave guides, and other wired media and wireless media such as acoustic, RF, infrared, and other wireless media.

The Internet has recently seen explosive growth by virtue of its ability to link computers located throughout the world. As the Internet has grown, so has the WWW. Generally, the WWW is the total set of interlinked hypertext documents residing on HTTP (hypertext transport protocol) servers around the world. Documents on the WWW, called pages or Web pages, are typically written in HTML (Hypertext Markup Language) or some other markup language, identified by URLs (Uniform Resource Locators) that specify the particular machine and pathname by which a file can be accessed, and transmitted from server to end user using HTTP. Codes, called tags, embedded in an HTML document associate particular words and images in the document with URLs so that a user can access another file, which may literally be halfway around the world, at the press of a key or the click of a mouse. These files may contain text (in a variety of fonts and styles), graphics images, movie files, media clips, and sounds as well as Java applets, ActiveX controls, or other embedded software programs that execute when the user activates them. A user visiting a Web page also may be able to download files from an FTP site and send messages to other users via email by using links on the Web page.

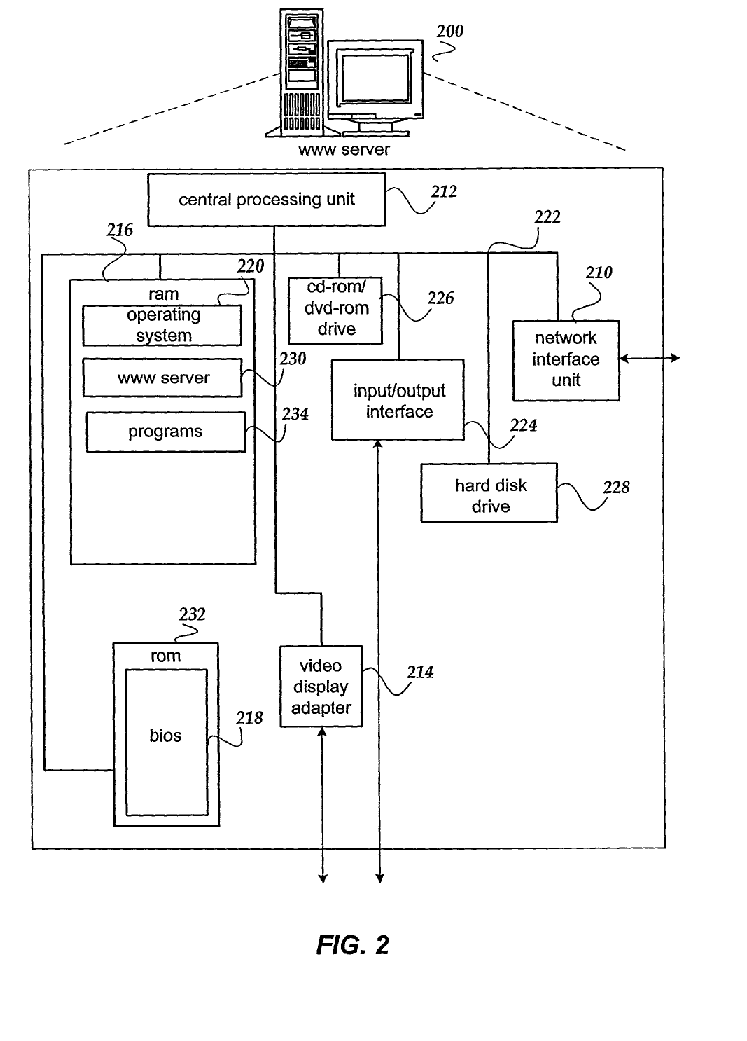

A server providing a WWW site, as the server described in more detail in conjunction with FIG. 2 may, is a computer connected to the Internet having storage facilities for storing hypertext documents for a WWW site and running administrative software for handling requests for the stored hypertext documents. A hypertext document normally includes a number of hyperlinks, i.e., highlighted portions of text which link the document to another hypertext document possibly stored at a WWW site elsewhere on the Internet. Each hyperlink is associated with a URL that provides the location of the linked document on a server connected to the Internet and describes the document. Thus, whenever a hypertext document is retrieved from any WWW server, the document is considered to be retrieved from the WWW. As is known to those skilled in the art, a WWW server may also include facilities for storing and transmitting application programs, such as application programs written in the JAVA programming language from Sun Microsystems, for execution on a remote computer. Likewise, a WWW server may also include facilities for executing scripts and other application programs on the WWW server itself.

A user may retrieve hypertext documents from the WWW via a WWW browser application program located on a wired or wireless device. A WWW browser, such as Netscape's NAVIGATOR® or Microsoft's INTERNET EXPLORER®, is a software application program for providing a graphical user interface to the WWW. Upon request from the user via the WWW browser, the WWW browser accesses and retrieves the desired hypertext document from the appropriate WWW server using the URL for the document and HTTP. HTTP is a higher-level protocol than TCP/IP and is designed specifically for the requirements of the WWW. HTTP is used to carry requests from a browser to a Web server and to transport pages from Web servers back to the requesting browser or client. The WWW browser may also retrieve application programs from the WWW server, such as JAVA applets, for execution on a client computer.

FIG. 2 shows an exemplary server that may operate to provide a WWW site, among other things. When providing a WWW site, server 200 transmits WWW pages to the WWW browser application program executing on requesting devices to carry out this process. For instance, server 200 may transmit pages and forms for receiving information about a user, such as address, telephone number, billing information, credit card number, etc. Moreover, server 200 may transmit WWW pages to a requesting device that allow a consumer to participate in a WWW site. The transactions may take place over the Internet, WAN/LAN 100, or some other communications network known to those skilled in the art.

Those of ordinary skill in the art will appreciate that the server 200 may include many more components than those shown in FIG. 2. However, the components shown are sufficient to disclose an illustrative environment for practicing the present invention. As shown in FIG. 2, server 200 is connected to WAN/LAN 100, or other communications network, via network interface unit 210. Those of ordinary skill in the art will appreciate that network interface unit 210 includes the necessary circuitry for connecting server 200 to WAN/LAN 100, and is constructed for use with various communication protocols including the TCP/IP protocol. Typically, network interface unit 210 is a card contained within server 200.

Server 200 also includes processing unit 212, video display adapter 214, and a mass memory, all connected via bus 222. The mass memory generally includes random access memory (“RAM”) 216, read-only memory (“ROM”) 232, and one or more permanent mass storage devices, such as hard disk drive 228, a tape drive (not shown), optical drive 226, such as a CD-ROM/DVD-ROM drive, and/or a floppy disk drive (not shown). The mass memory stores operating system 220 for controlling the operation of server 200. It will be appreciated that this component may comprise a general purpose server operating system as is known to those of ordinary skill in the art, such as UNIX, LINUX™, or Microsoft WINDOWS NT®. Basic input/output system (“BIOS”) 218 is also provided for controlling the low-level operation of server 200.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory may also store program code and data for providing a WWW site. More specifically, the mass memory may store applications including WWW server application program 230, and programs 234. WWW server application program 230 includes computer executable instructions which, when executed by server 200, generate WWW browser displays, including performing the logic described above. Server 200 may include a JAVA virtual machine, an SMTP handler application for transmitting and receiving email, an HTTP handler application for receiving and handing HTTP requests, JAVA applets for transmission to a WWW browser executing on a client computer, and an HTTPS handler application for handling secure connections. The HTTPS handler application may be used for communication with an external security application to send and receive sensitive information, such as credit card information, in a secure fashion.

Server 200 also comprises input/output interface 224 for communicating with external devices, such as a mouse, keyboard, scanner, or other input devices not shown in FIG. 2. Likewise, server 200 may further comprise additional mass storage facilities such as optical drive 226 and hard disk drive 228. Hard disk drive 228 is utilized by server 200 to store, among other things, application programs, databases, and program data used by WWW server application program 230. For example, customer databases, product databases, image databases, and relational databases may be stored.

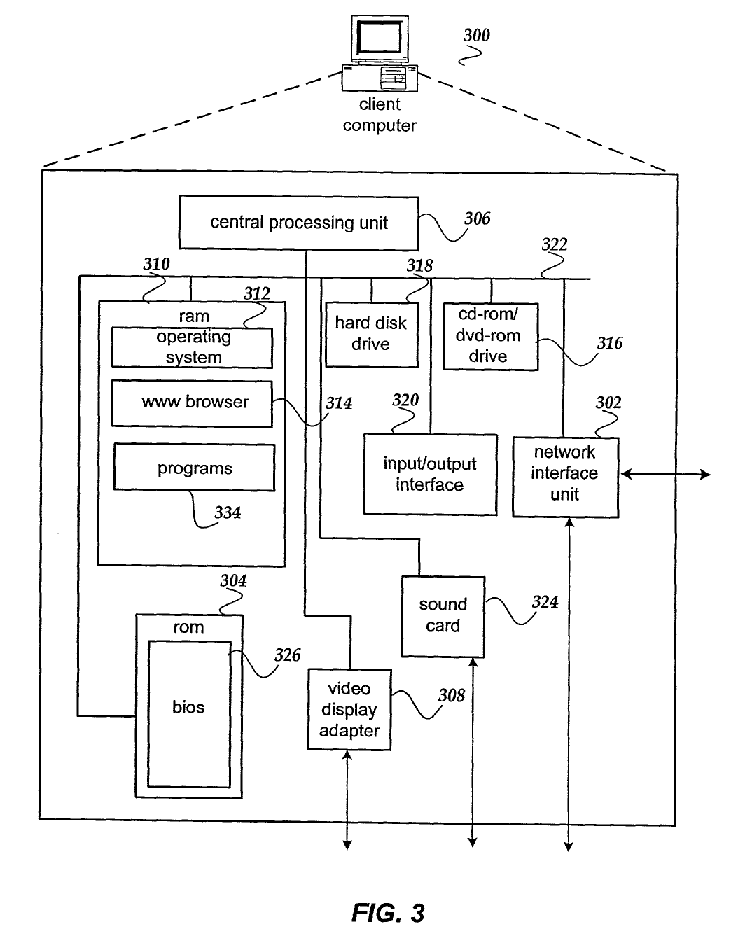

FIG. 3 depicts several components of client computer 300. Those of ordinary skill in the art will appreciate that client computer 300 may include many more components than those shown in FIG. 3. However, it is not necessary that those generally-conventional components be shown in order to disclose an illustrative embodiment for practicing the present invention. As shown in FIG. 3, client computer 300 includes network interface unit 302 for connecting to a LAN or WAN, or for connecting remotely to a LAN or WAN. Those of ordinary skill in the art will appreciate that network interface unit 302 includes the necessary circuitry for such a connection, and is also constructed for use with various communication protocols including the TCP/IP protocol, the particular network configuration of the LAN or WAN it is connecting to, and a particular type of coupling medium. Network interface unit 302 may also be capable of connecting to the Internet through a point-to-point protocol (“PPP”) connection or a serial line Internet protocol (“SLIP”) connection as known to those skilled in the art.

Client computer 300 also includes BIOS 326, processing unit 306, video display adapter 308, and memory. The memory generally includes RAM 310, ROM 304 and a permanent mass storage device, such as a disk drive. The memory stores operating system 312 and programs 334 for controlling the operation of client computer 300. The memory also includes WWW browser 314, such as Netscape's NAVIGATOR® or Microsoft's INTERNET EXPLORER® browsers, for accessing the WWW. It will be appreciated that these components may be stored on a computer-readable medium and loaded into memory of client computer 300 using a drive mechanism associated with the computer-readable medium, such as a floppy disk drive (not shown), optical drive 316, such as a CD-ROM/DVD-ROM drive, and/or hard disk drive 318. Input/output interface 320 may also be provided for receiving input from a mouse, keyboard, or other input device. The memory, network interface unit 302, video display adapter 308, and input/output interface 320 are all connected to processing unit 306 via bus 322. Other peripherals may also be connected to processing unit 306 in a similar manner.

As will be recognized from the discussion below, aspects of the invention may be embodied on server 200, on client computer 300, or on some combination thereof. For example, programming steps may be contained in programs 334 and/or programs 234.

Illustrative Development Environment

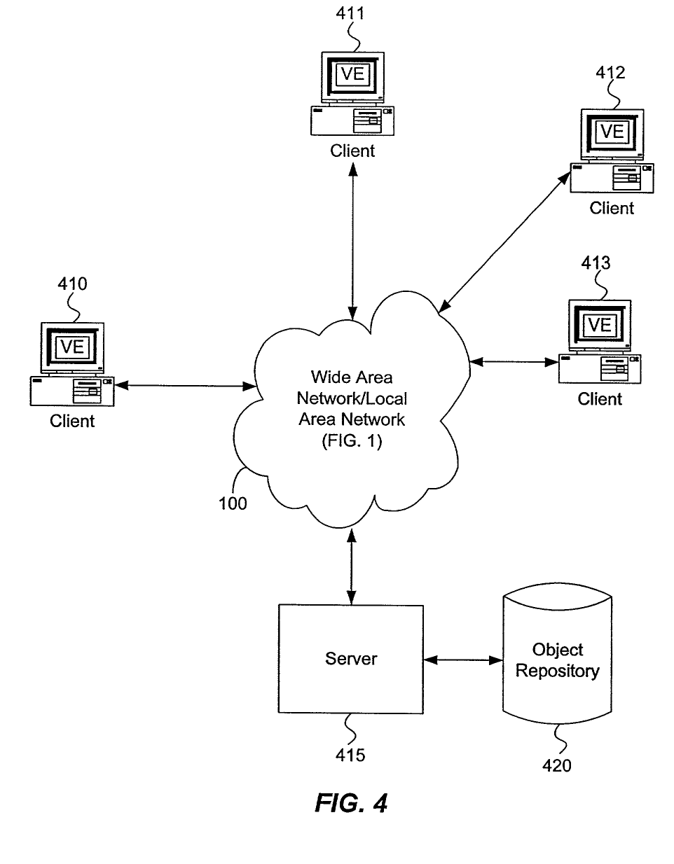

FIG. 4 illustrates an exemplary environment in which the invention operates in which clients executing visual development environments are coupled to a server having access to server objects, according to one embodiment of the invention. The environment includes clients 410-413, WAN/LAN 100, server 415, and object repository 420.

Clients 410-413 are coupled to server 415 through WAN/LAN 100. Server 415 is coupled to WAN/LAN 100 and may be coupled to object repository 420. Alternatively, server 200 may include object repository 420 internally.

Clients 410-413 are any devices capable of connecting with WAN/LAN 100. Such devices may include devices that typically connect using a wired communications medium such as personal computers, multiprocessor systems, microprocessor-based or programmable consumer electronics, network PCs, and the like. Such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like. In addition, clients 410-413 may also include devices that are capable of connecting using a wired or wireless communication medium such as PDAs, POCKET PCs, wearable computers, and other devices mentioned above that are equipped to use a wired and/or wireless communications medium. An exemplary client that may connect with WAN/LAN 100 is client computer 300 of FIG. 3.

Server 415 is any device capable of connecting with WAN/LAN 100 and responding to requests from other devices, such as server-side object requests. The set of such devices capable of acting as a server may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like. Alternatively, server 415 may be any device that is capable of connecting using a wired or wireless communication medium such as a PDA, POCKET PC, wearable computer, or other device mentioned above that is equipped to use a wired and/or wireless communications medium. An exemplary server that may connect with WAN/LAN 100 is server 200 of FIG. 2.

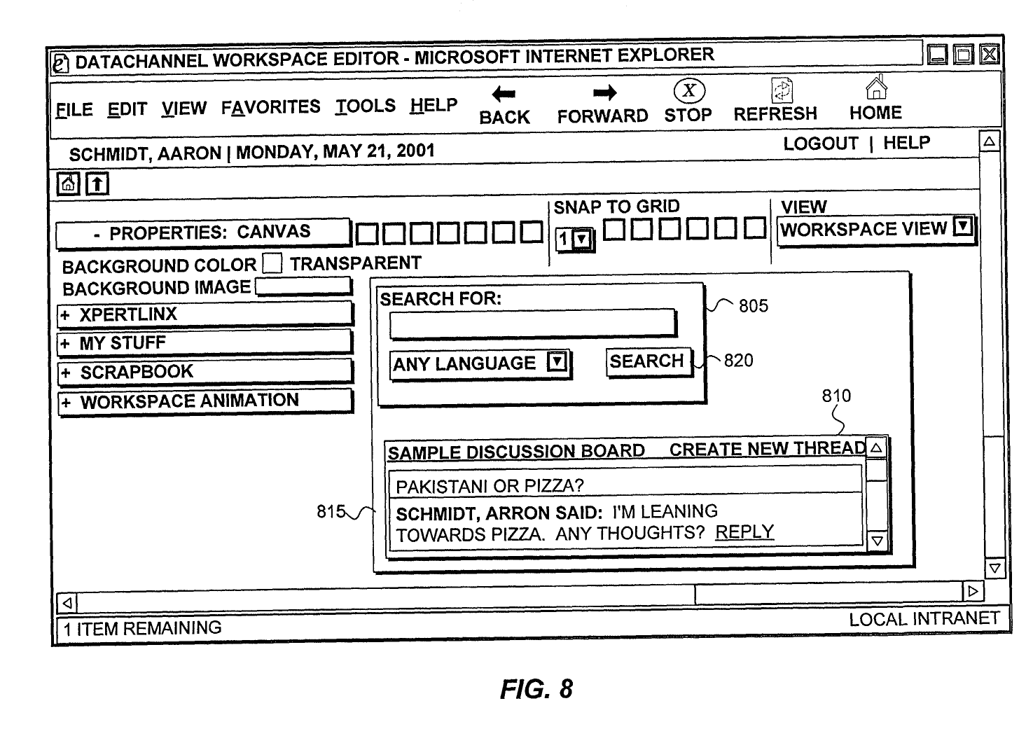

Server 415 interacts with object repository 420 to respond to requests for server-side objects. FIG. 8 shows examples of server-side objects rendered in a visual development environment executing on a client. Server-side objects search control 805 and discussion board 810 are shown in visual development environment 800. In developing an application, a software developer may select an icon associated with a server-side object. Such an icon may be selected from a set of available icons from a toolbar. Each icon may be associated with a server-side object, a client-side object, or some other object. In operation, a user may select the icon and “drag” it onto a design screen, such as design screen 815. After the icon is dragged onto the design screen, when the icon is associated with a server-side object, a proxy of the server-side object is created and displayed.

The word “proxy” is used because the graphical object shown in the visual development environment is intended to appear similar to the object that is shown when the developed application executes. That is, after a software developer has completed an application and the application is executed and actually interacts with server-side objects in the course of execution, objects are shown on a computer screen similar to the proxies shown when developing using the visual development environment. This is useful, among other reasons, because it allows the software developer to graphically see approximately what will be displayed when the application is executed. This aids the software developer in placing objects in the application.

One approach to creating the proxy is to create representations and store them in the visual development environment itself. As long as the server-side objects do not change, this approach works well. Unfortunately, if a server-side object changes, this approach may require that the representation in the visual development environment change as well. This may require a new version of the visual development environment to be distributed to users who then install the new version. Alternatively, other mechanisms may be required to keep the representations and the server-side objects in sync.

Another approach to creating the proxy is to have the visual development environment request information from the server about each server-side object selected.

One way of doing this is for the visual development environment to request the server-side object similar to how an application would when executing. Upon receipt of the server-side object, the visual development environment may deactivate elements and perform other processing so that the graphical elements of the server-side object are shown, but some of the actual functionality is removed. For example, a server-side object may have a button, such as search button 820 of FIG. 8. Clicking on the search button may cause a function to be invoked which exits the visual environment. Selecting search button 820 of FIG. 8, for example, may cause the control to post a search string to a search engine such as AltaVista. By removing this functionality from the object, the visual development environment may display the object graphically without allowing user interaction with the object to cause the visual development environment to be exited.

Another example of functionality that may be removed from a server-side object is scripts associated with the server-side object. For example, the server-side object may include some java script or other scripting or programming language. Scripts and programmatic steps may be removed or replaced with non-interactive scripts.

Additionally, server-side objects may have references to graphics that are no longer valid from the visual development environment. For example, a server-side object may have a relative address for an image contained in the server-side object. The relative address may specify that a bitmap for the image may be found in a sibling directory from the directory in which the server-side object is stored. For example, if a server-side object was stored in c:binobjects, it may reference an image in c:binimages by giving a relative path, such as “../images/iconjpg”. While this relative path tells exactly where the image may be found when a server-side object executes on the server, it may need to be translated for the proxy to find the images. For example, by replacing the relative path “../images/iconjpg” with an absolute address, such as “http://www.server.com/images/icon.jpg,” the visual development environment can have the proxy correctly display its graphical components.

Alternatively, deactivating elements and fixing image references may occur on the server. For example, a visual development environment may request a processed client-side user interface (UI) for a server-side object from the server. Upon receipt of the request, the server may deactivate interactive elements and replace relative paths with absolute paths in images.

To determine which server-side objects are available, the visual development environment may send a request to the server. The server may send a set of icons to the visual development environment, a textual list including attributes, or other information that indicates which server-side objects are available. In addition, if objects are related, this may also be sent. For example, a control (object) may inherit from another control or be the parent of another control.

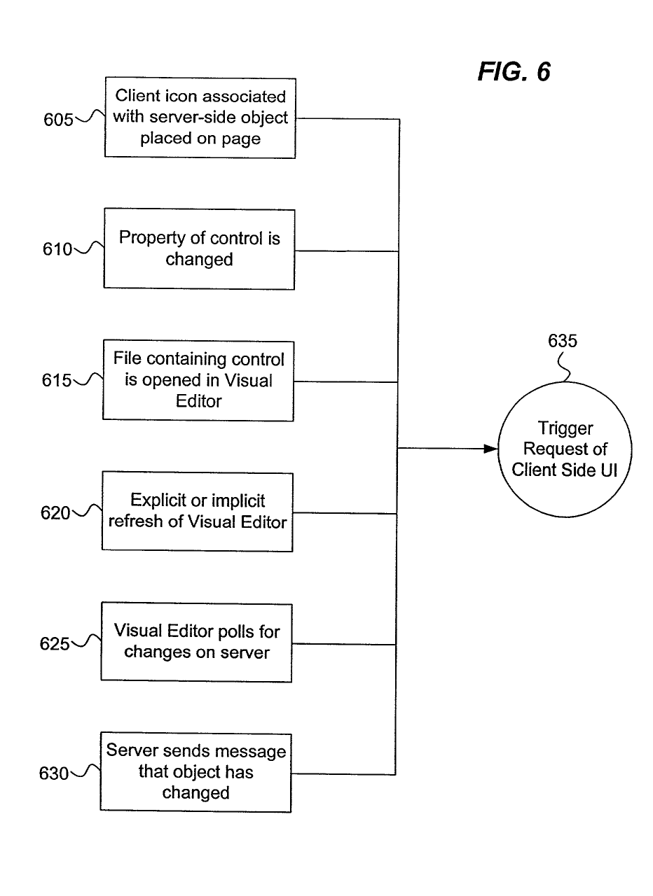

From time to time server-side objects may be changed and updated. If these changes are not propagated to a proxy in the visual development environment, how the server-side object displays when executed by an application and how the proxy for the server-side object displays in the visual development environment may differ. Many events may cause the visual development environment to re-query a server for the most up-to-date information about server-side objects. For example, when the object is first placed in a form on the visual development environment, the visual development environment may query the server for information so that it may display a proxy representing the server-side object. When a software development project is opened, this may trigger re-querying the server. Other events may also trigger updating a visual development environment's proxies, such as those discussed in conjunction with FIG. 6.

Object repository 420 stores server-side objects. It may be coupled to many servers or it may be incorporated within a server. Object repository 420 may be used to retrieve server-side objects upon demand by a server, such as server 415. In addition, object repository 420 may be used to store new or updated objects. Object repository 420 may be implemented as a database or otherwise without departing from the spirit or scope of the invention.

Illustrative Method for Displaying Client-side User Interface

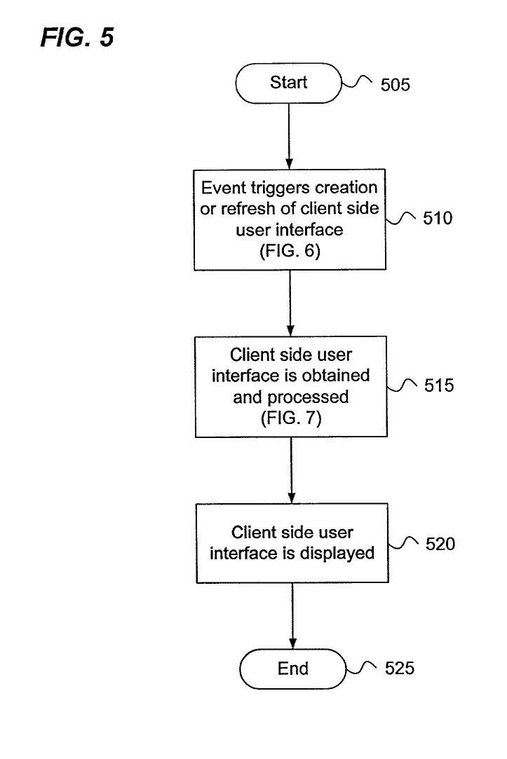

FIG. 5 shows a flow chart for displaying a client-side interface for a server-side object, according to one embodiment of the invention. The process begins at block 505 before an event triggers a refresh or creation of a client-side UI.

At block 510, an event causes the visual development environment to create or refresh a client-side UI for a server-side object. A client-side UI is what has been referred to earlier as a graphical object (or proxy) that is displayed in the visual development environment. The graphical object proxies for the server-side object. Events that may trigger a refresh or creation of a client-side UI include those described in more detail in conjunction with FIG. 6. One event that triggers the creation of a client-side UI is dragging an icon associated with a server-side object onto the visual development environment's workspace.

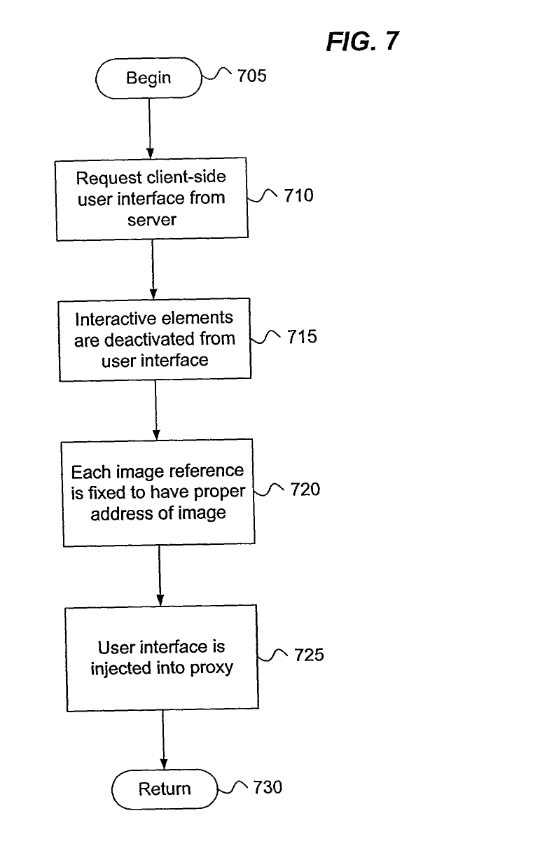

At block 515, a client-side UI is obtained and processed for displaying in the visual development environment's workspace. Processing that may occur on the object is described in more detail in conjunction with FIG. 7. For example, a link to http://www.favorites.com may be deadened to cause it to appear as text that does not link to the site when clicked upon.

At block 520, the client-side UI is displayed. For example, referring to FIG. 8, after dragging an icon associated with a server-side search control onto design screen 815 and after any processing is completed, a search control 805 is displayed as a proxy for the server-side search control.

At block 525, processing ends. At this point, an event has triggered the creation or refresh of a client-side UI. Client-side UI has been retrieved from a server and processed. The processed result is displayed graphically as a proxy for the server-side object.

FIG. 6 illustrates events that may trigger a request of the client-side UI for a server-side object, according to one embodiment of the invention. The events may occur at any time. When an event occurs while a visual development environment is executing, the visual development environment may trigger a request for the client-side UI of a server-side object.

Event 605 occurs when an icon associated with a server-side object is placed on a visual development environment design screen. For example, referring to FIG. 8, when a developer drags an icon associated with a server-side search control, triggering occurs.

Event 610 occurs when a property of a control (object) displayed in a design screen of the visual development environment is changed. For example, a developer may change the zipcode associated with a weather control. Changing this would trigger a request for the client-side UI of a server-side object.

Event 615 occurs when a file containing one or more controls is opened in a visual development environment. For example, when a software developer begins work on a project, he or she may open many files associated with the project. Each file may include some objects that are associated with server-side objects. Upon opening such a file, a request for the client-side UI of objects in the file may be triggered.

Event 620 occurs when a visual development environment is explicitly or implicitly refreshed. For example, the visual development environment may contain a menu option for explicitly refreshing all client-side UIs for server-side objects contained within a project. Upon selection of the option, triggering of refresh occurs. Additionally, or alternatively, the visual development environment may implicitly refresh upon certain events, for example after a certain amount of time has elapsed, when the visual development environment is resized or comes to the foreground (after being behind other applications), etc.

Event 625 occurs when after polling the server, the visual development environment determines that some of its client-side UIs to be out-of-date. For example, referring to FIG. 4, visual development environments executing on clients 410-413 may periodically check with server 415 to determine whether any relevant server-side objects have changed recently. Relevant refers to a server-side object for which a visual development environment has a client-side UI displayed for. When a relevant server-side object has changed, this may trigger a request for an updated client-side UI.

Event 630 occurs when a server sends a message that an object has changed. A server may, for example, send messages to each executing visual development environment when a server-side object has changed. Each visual development environment may then determine if the server-side object change is relevant, i.e., whether the respective visual development environment has a client-side UI for the server-side object.

Block 635 is reached when any of events previously mentioned occur. After such an event occurs, processing continues at block 515 of FIG. 5.

It will be recognized other events may trigger a request of client-side UI. Such events may automatically occur or be caused by user action. Triggering using such events is contemplated by the invention and within its spirit and scope.

FIG. 7 shows a flow chart for obtaining and processing a client-side user interface, according to one embodiment of the invention. The process begins at block 705 when a request to obtain a client-side UI is received.

At block 710, a client-side UI is requested from the server. This may be done by the proxy, by the visual development environment, and/or through some other mechanism. For example, referring to FIG. 4, a request comes from client 410 for a client-side UI for search control 805 of FIG. 8.

At block 715, interactive elements are deactivated from the user interface. As previously discussed, server-side objects may include objects that will cause events to occur when selected. For example, the search button on search control 805 of FIG. 8 may, if selected, cause actions to be taken including launching a Web browser and searching for a particular phrase. An HTTP hyperlink may, if clicked on, cause a Web browser to be launched and an HTTP document to be retrieved from the Web. Such elements are deactivated or “deadened” so that they do not respond to these actions while in a visual development environment.

At block 720, each image reference may be modified to have a proper address of the image. As discussed previously, an image may be referenced relatively. When data about the server-side object is sent to the visual development environment, the relative references may no longer be valid. To fix this, each reference is changed, as necessary, to refer correctly to the originally referenced image. For example, a reference to ../images/image.gif may be changed to a reference of http://www.favorites.com/images/image.gif.

At block 725, the user interface is injected into a proxy. Injection refers to having the deactivated attributes of the user interface inserted into a client-side object that is then displayed graphically in the visual development environment.

At block 730, the process returns to the calling process. At this point, the client-side UI for a server-side object has been requested. Interactive elements within the client-side UI have been deactivated. Image references within the client-side UI have been fixed, when needed, to refer correctly to the original image referred to in the server-side object. The resulting deactivated UI has been inserted into a proxy, ready for display.

It will be recognized that some interactive elements may not need to be deactivated. For example, a list box having multiple items will not generally need to be deactivated. A developer developing an application may interact with the list box and see what items are available. A text input box may still receive text and thus not be totally or even partially deactivated. In general, those elements that cause the visual development environment to be exited or lose focus will be deactivated.

In light of this disclosure, it will be recognized that many variations of the above processes may be implemented without departing from the spirit or scope of this invention.

Illustrative Visual Development Environment

FIG. 8 shows an exemplary visual development environment with some client-side user interfaces displayed, according to one embodiment of the invention. The visual development environment includes design screen 815 and other features for developing a software application visually. Design screen 815 includes search control 805 and discussion board 810. Search control 805 includes search button 820.

The term “visual development environment” includes any program that may be used to develop software. For example, one such program that may be used is Microsoft's notepad program. Two UNIX programs are VI and EMACS. These programs allow entry of text (code) and saving of text. A C or C++ program could be developed using notepad, VI, and/or EMACS. Certainly, a C or C++ compiler may also be required to produce an executable. As such, the compiler may be part of another visual development environment, or if closely coupled to the editor, such as EMACS, may be part of the visual development environment of the code entry tool-in this case EMACS.

Another visual development environment is Microsoft's VISUAL STUDIO. This development environment includes many interconnected components that can work with each other. For example, VISUAL STUDIO may include VISUAL BASIC, VISUAL C++, VISUAL J++, and other development tools. In some visual development environments, placing a graphical component on a screen, such as a message box, may be done by dragging an icon associated with the message box into the visual development environment. Other visual development environments, such as VI and notepad, do not allow objects to be dragged into them as part of software development.

Web development tools, client/server development tools, and all other software development tools are each a “visual development environment.”

Some features of the visual development environment shown in FIG. 8 have been described in conjunction with FIG. 4. It will be recognized that visual development environment features found in other visual development environments may be included within the shown visual development environment without departing from the spirit or scope of the invention.

It will also be recognized that search control 805 and discussion board 810 proxy for server-side objects. Proxies for other server-side objects may be added to the visual development environment shown without departing from the spirit or scope of the invention.

Illustrative Transformation of a Server-Side Object to a Client-Side User Interface

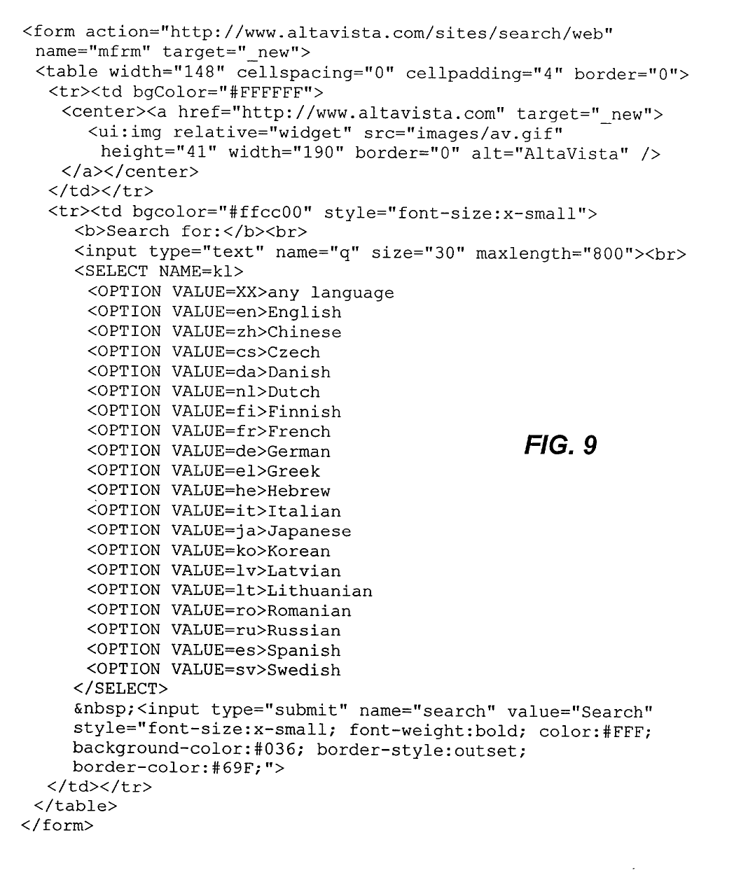

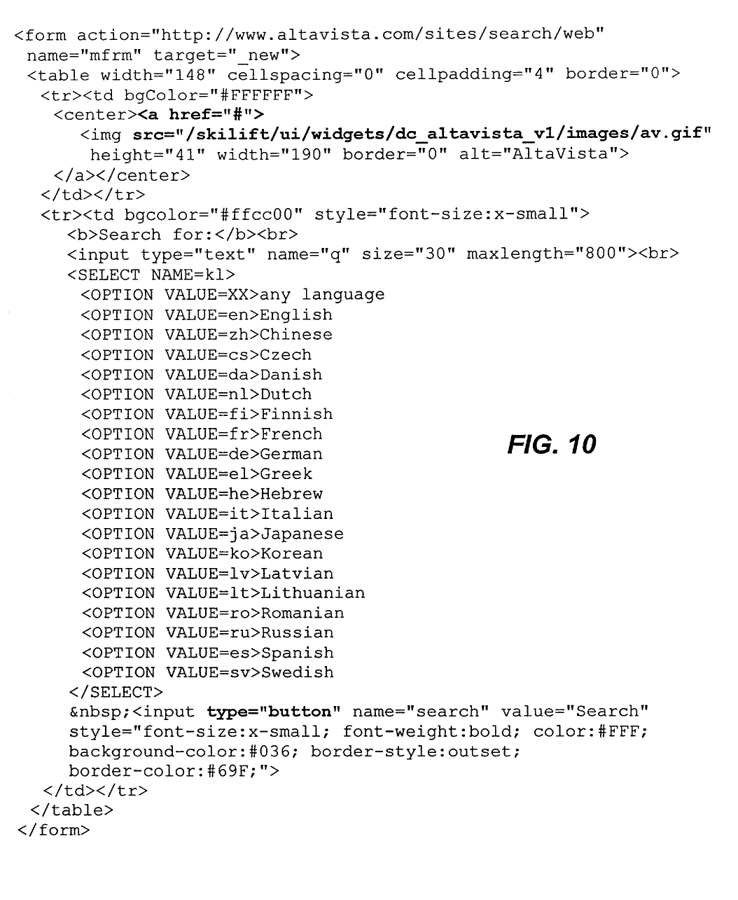

FIGS. 9-10 illustrate code for a server-side object that has been transformed into code for a client-side user interface, according to one embodiment of the invention. FIG. 9 shows a JavaServer Page for a server-side object. FIG. 10 shows HTML code for a client-side UI generated from the sever-side object. When rendered graphically in a browser, the code generates an object similar to search control 805 of FIG. 8 with an image above the object.

In FIG. 10 some elements that have been changed are shown in bold. Specifically, the relative reference to the graphic in FIG. 9 has been changed. This may be done through mechanisms of the JavaServer Page. Specifically, when called, code in the JavaServer Page may return a fully qualified path for an image. Or, it might return a relative image. In the latter case, the image is relative to the location of the server control, but is being viewed in the context of the page or application that is viewing the server control. As a result, the relative image will not properly resolve, and the process described in detail in conjunction with FIG. 7 will convert the image reference to a fully qualified reference so that the image can be found.

In addition, a submit action of FIG. 9 has been changed to a normal button in FIG. 10. The result is that when a developer clicks on a search button, such as the search button in search control 805 of FIG. 8, a browser window is not brought up and activated causing the visual development environment to lose focus.

In addition, should the form contain an image input element, the image input element is converted to an image element, because the former causes a form submission, whereas the latter does not.

The code shown in FIG. 9 requires relatively few changes to be transformed into a client-side UI. It will be recognized that code for a server-side object may contain many image references that need to be modified for use in a client-side UI. In addition a server-side object may contain many active elements that need to be deactivated in a client-side UI.

The various embodiments of the invention may be implemented as a sequence of computer implemented steps or program modules running on a computing system and/or as interconnected machine logic circuits or circuit modules within the computing system. The implementation is a matter of choice dependent on the performance requirements of the computing system implementing the invention. In light of this disclosure, it will be recognized by one skilled in the art that the functions and operation of the various embodiments disclosed may be implemented in software, in firmware, in special purpose digital logic, or any combination thereof without deviating from the spirit or scope of the present invention.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of displaying a graphical representation of a server-side object, comprising:
(a) upon a triggering event, requesting code that represents a user interface from a server;
(b) deactivating at least one element in the requested code, wherein the element causes an action to be taken when activated; and
(c) displaying the graphical representation of the server-side object using the requested code.

2. The method of claim 1, wherein before deactivation, the element in the requested code is activated when a graphical object associated with the element is selected.

3. The method of claim 2, wherein the graphical object is a button or a hypertext link.

4. The method of claim 2, further comprising changing an address of an image in the code.

5. The method of claim 4, wherein the address is a relative reference to a location of the image.

6. The method of claim 1, wherein the code is written in a markup language.

7. The method of claim 6, wherein the markup language is a hypertext markup language.

8. The method of claim 2, wherein the triggering event includes at least one of: placing an icon associated with the server-side object on a page in a visual development environment; changing a property of a control; opening a file containing a control in the visual development environment; refreshing the visual development environment; polling by the visual development environment that indicates that the server-side object is changed; and a message sent from a server indicating that the server-side object is changed.

9. The method of claim 2, wherein the graphical representation is visually similar to what is generated when an executing application requests the server-side object.

10. A modulated data signal including computer-executable instructions for displaying a graphical representation of a server-side object in a visual development environment, comprising:
(a) upon a triggering event, requesting code that represents a user interface from a server;
(b) deactivating at least one element in the requested code, wherein the element causes an action to be taken when activated; and
(c) displaying the graphical representation of the server-side object using the requested code.

11. The modulated data signal of claim 10, further comprising changing in the code a reference to an image to another reference to the image.

12. The modulated data signal of claim 11, wherein before deactivation, activating the element in the code causes an action to occur.

13. The modulated data signal of claim 12, wherein activating the element includes selecting a graphical object associated with the element, wherein the graphical object is a proxy in a visual development environment, wherein the proxy proxies for the server-side object.

14. The modulated data signal of claim 13, wherein the graphical object includes at least one of a button and a hypertext link.

15. The modulated data signal of claim 11, wherein the code is written in a markup language.

16. The modulated data signal of claim 11, wherein the triggering event includes at least one of placing an icon associated with the server-side object on a page in the visual development environment; changing a property of a control; opening a file containing a control in the visual development environment; refreshing the visual development environment; polling by the visual development environment that indicates that the server-side object is changed; and a message sent from a server indicating that the server-side object is changed.

17. The modulated data signal of claim 1 1, wherein the graphical representation includes dimensions that are visually similar to a graphical object that is generated when an executing application requests the server-side object.

18. A computer-readable medium having computer-executable instructions for creating Web application programs in a visual development environment, comprising:
(a) upon a triggering event, requesting code that represents a user interface from a server;
(b) deactivating at least one element in the requested code, wherein the element causes an action to be taken when activated; and
(c) displaying the graphical representation of the server-side object using the requested code.
(d)

19. The computer-readable medium of claim 18, further comprising changing in the code a reference to an image to another reference to the image.

20. A method of displaying a graphical representation of a server-side object, comprising:
(a) means for requesting code that represents a user interface from a server when a triggering event occurs;
(b) means for deactivating at least one element in the requested code, wherein the element causes an action to be taken when activated; and
(c) means for displaying the graphical representation of the server-side object using the requested code.
